(19) United States
(12) Patent Application Publication
(10) Pub. No.: US 2005/0256819 A1
(43) Pub. Date: Nov. 17, 2005

(54) Semantic adaptive framework (SAF) for enabling system self selection of actions by reasoning about self knowledge

(76) Inventors: Clark Tibbs, Newark, OH (US); John A. Yanosy JR., Grapevine, TX (US)

Correspondence Address: Thomas A. O'Rourke;Bodner & O'Rourke, 425 Broadhollow Road, New York, NY, 11747, US

(21) Appl. No.: 11/117,073

(22) Filed: Apr. 28, 2005

Related U.S. Application Data
(60) Provisional application No. 60/566,018, filed on Apr. 28, 2004.

(51) Int. Cl. G06F 15/18; G06N 5/00; G06F 17/00; G06N 5/02

(52) U.S. Cl. 706/46; 706/12

(57) ABSTRACT

A system and method of defining system behavior is described. The invention is directed to selecting optimal actions by a process of reasoning about a systems self knowledge. One or more of the following parameters are considered in the process, the environmental state, system state, user situation, available system capabilities and network accessible functions and services and knowledge represented as ontologies.

This is a conversion of U.S. Provisional Patent Application Ser. No. 60/566,018 filed Apr. 28, 2004 the disclosures of which are incorporated herein by reference.

### BACKGROUND OF THE INVENTION

Machine Learning, Tom M. Mitchell, McGraw-Hill, ISBN0-07-042807-7
Hidden Order—How Adaptation Builds Complexity, John H. Holland, Addison Wesley, ISBN 0-201-40793-0

### SUMMARY OF THE INVENTION

The present invention is directed to concepts for a Semantic Adaptive Framework (SAF) that defines system behavior through selection of optimal actions by a process of reasoning about its self knowledge, considering the environmental state, system state, user situation, available system capabilities and network accessible functions and services and knowledge represented as ontologies. The SAF though capable of operating as a self contained system is also capable of operating in a Network Centric Environment where the SAF system is distributed across multiple SAF nodes, all capable of sharing knowledge with each other with respect to the overall environment and capabilities of each node. With the distributed SAF system using network communications and knowledge sharing the overall capabilities are expanded by the networked set of SAF nodes. The SAF has a structure that enables reasoning across its self knowledge, whether self contained or also accessed through a network, or whether knowledge derived from sharing of knowledge between SAF nodes, for action selection through a common process, while enabling the customization of its self knowledge for unique application domains, problem specific contexts, and different sets of available actions. For purposes of explanation, a universal popular application is described herein: the web content and services environment. It is utilized to explore and describe the concepts underlying the SAF framework.

This invention sets forth a conceptual framework for using meta knowledge in the form of ontologies for the purpose of defining system responses considering problem context, user context, environment knowledge, and available responses. Multiple applications appear to be suitable for this approach, and a combination of a priori knowledge and machine learning can enhance the accuracy and flexibility of the adaptive behavior. In addition an overall framework is described at a high level to enable an SAF reasoning control program to utilize a common SAF structure description to make about potential interim classification results.

Current research indicates that a combination of inductive learning and analytic learning can be used for the SAF system. Example Applications include but are not limited to User Context and Domain Meta Specifications for Web Networked Information Content and Services

### BRIEF DESCRIPTION OF THE DRAWINGS

FIG. 1 shows a Conceptual Model for Intelligent Adaptive Framework

FIG. 2 depicts an SAF Model with Knowledge and Reasoning Elements

FIG. 3 represents a Semantic Web with Ontology Directory

FIG. 4 demonstrates a User Context Mediated Web Access

FIG. 5 shows a Context Selection Using a Machine Learning Classification Algorithm

FIG. 6 depicts a Context Relationship Creation

FIG. 7 shows an SAF Interacting with an external system or network

FIG. 8 shows an SAF Contained within System

FIG. 9 depicts an SAF In a distributed environment of providers users, services, and information objects

FIG. 10 illustrates the type of information contained in the “Context Ontology.”.

### DETAILED DESCRIPTION OF THE INVENTION

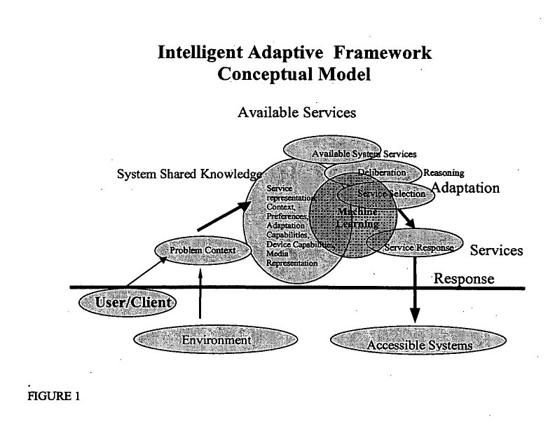

The key SAF concepts include the ability to infer the appropriate system action or response from deliberation and reasoning about the user or system environment, the problem context, and the set of available system responses. Each of these three SAF aspects is defined as knowledge elements in the SAF structure. The flow of dependency is illustrated in See FIG. 1 and the following set of inference. A combination of a'priori knowledge and machine learning is used to enable the SAF framework to adapt its performance accuracy with experience. A key concept for the SAF framework is the ability to apply a common sequential control logic to the various ontologies representing the following generic knowledge categories. For a specific application each category of knowledge listed below will be implemented with specific ontologies in the application domain, thus providing a generic control framework for sequencing through knowledge categories with specific application knowledge to guide the selection of a system response. This capability to have a generic control framework combined with the use of specific domain ontologies gives the SAF the ability to be used in many different applications. All that is required is the development of specific domain ontologies for each SAF category according to semantic definitions of knowledge compatible with the SAF sequencial analysis.

SAF knowledge is sharable among a set of SAF nodes through Web Services where each SAF node makes its knowledge and reasoning results available to other SAF nodes. The approach enables a networked SAF systems with local reasoning appropriate to the system capabilities of each node, while enabling influence of its selection through the shared knowledge among them. The use of standard Web Services standards such as UDDI and WSDL enable a common platform independent network of SAF system within a heterogeneous network.
<user environment>→<problem context>→<shared SAF knowledge>→<available system responses>→<selected system response>
   SAF Applications

A common aspect of the following SAF applications is the desire to define and evolve system behavior through reasoning and the acquisition of knowledge, rather than requiring the development of new software programs. There also is a sense of a client and problem context. The client may be a system, a human, or a program, while the problem context defines the specific intent and purpose of the reasoning and response selection from a particular problem viewpoint. Thus in some of the applications below the problem context may be defined from a human client perspective, while in others the client and problem perspective may be associated with a system or program.
Heterogeneous Network Application Environments—As a framework for enabling a distributed set of nodes to respond as a single system to user situations, e.g., a service provider providing autonomic response using multiple services in a coordinated manner
Communications Management Framework—As a framework for selecting appropriate communication services for users in different situations and environments
System Management Framework—As a framework for selecting system actions in different system states for specific problems in different management domains such as performance, failure, configuration
Personal Content Management Framework—As a framework for enabling a user or provider to determine the access and sharing of diverse content files and media, with others in different situations and environments
Personal Web Access Preferences—As a framework that selects different web sites and web services for users in different context situations
Provider Services Management (Information Assurance)—As a framework for selecting appropriate AAA, Authentication, Authorization, and Accounting services for a user access to provided services, especially when different users have different suites of services and where different services have different AAA methods.
Information Object Sharing—Subscribing, Publishing, and Query Management—A framework for managing which sets and types off information objects different user can access and publish in different user context situations.
   SAF Model

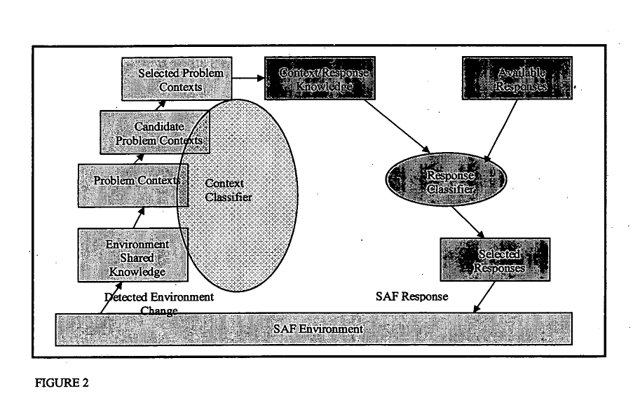

The model shown in FIG. 2 is sufficiently general that it can be applied to all of the above applications and others

The key concepts of the SAF model include the following:
Explcit Self knowledge or Network Accessible Knowledge enables reasoning to guide system behavior
The SAF model is based on reasoning about a n-tuple, defined as containing the following elements
<SAF Environment, Problem Context, Available System Responses, Context-Response-Relation→Selected Response> where the following occurs:
   The SAF environment data is analyzed by a classification learning algorithm to determine a candidate set of contexts, where context knowledge is not only the self knowledge of a single node but also the shared knowledge across SAF nodes comprising a heterogeneous network
   A classification algorithm is used to select the most appropriate problem context hypothesis
      The specific ontology for a problem context is queried to determine the shared knowledge state
   A Context-Response-Relation is specified to link context knowledge to a set of appropriate system responses, workflows or actions, or information content.
   The selected context and Context-Response-Relation expressions are evaluated to select responses, workflows, or content.
   The results of selection are shared with other SAF nodes
   Machine learning can be used to:
      Identify the candidate problem contexts
      Select the optimal problem context
      Identify the relation between problem context and system responses
      Select the optimal system response given the selected problem context and context-response relation
Knowledge of a user/client and SAF environment and problem context enables the system to provide more relevant response to user/client requests
Self knowledge can be represented as a set of domain ontology specifications, which are defined as containing <domain vocabulary, grammar rules, inference rules, and a'priori axioms>
Reasoning and deliberation in this system has the specific goal of selecting the most relevant system response, given a model of self knowledge that guides this selection process, and any shared knowledge among SAF nodes
Machine learning algorithms can be used to train the system into selecting more optimal system responses with experience. The specific machine learning algorithm used is not critical to the SAF model and its basic function, thus improvements in performance and accuracy can be made with more appropriate learning algorithms for different application environments and problem contexts
   Web Example

It is expected that a user's context is always in a state of flux and that different contexts can be used to infer different web services and information content that would be relevant to the user in that context.

Ontology meta specifications are the proposed method for specifying user relevant problem contexts and in the case of the Semantic Web meta specifications will also be available for web services and web content. The means for specifying, discovering and using the relationships between the user problem context and web content and services is focus of this SAF solution. For the web example the following simple inference reasoning expression holds.
<user problem context>→<web domain ontologies>→<web sites>→<web services, web content>
   Semantics and WWW

Recent trends in computer science are emphasizing the use of meta-data associated with information documents as a means for enabling interoperability between systems. This meta-data, for example an XML schema, at a minimum defines a data structure, the data elements, and the allowed values for the data elements. Though this enables a description of the syntax for information in a domain, it was determined that more expressive languages layered on top of XML could provide the semantic knowledge associated with this data for a specific knowledge domain, expressed as a domain ontology. This would then enable agents or programs committed to specific domain ontologies to collaborate and share knowledge with a specific semantic interpretation, even though they were not originally designed to interact with each other. The relationships between the domain ontologies, web sites, web services and web context can be defined in directory based services, where the web services are published via meta specifications such as WSDL and where UDDI provides the director publish and discovery capability. Web pages marked up with OWL, a web ontology language, defining an appropriate ontology for that web page, will enable better discovery and query of web content by applications.
<domain ontologies>→<web sites>→<web services, web content>

If a networked system such as the WWW had directories for domain ontologies, e.g., a means for publishing web sites consistent with specific ontologies, and a protocol defined for searching for web sites consistent with domain ontologies, than clients could search and use web content and web services more relevant to their purpose.

User Context and Semantic Web

With the above model, it is clear that special proxies, and/or agents could be used to automate the search and discovery process if there were better information concerning the needs and desires of the user. Thus we could expand the above model to also include ontologies not only about web sites, but ontologies defining attributes associated with user problem context, and then define relationships between web site domain ontologies and these problem context ontologies. Common user domain ontologies could be published in a public directory, from which user clients and agents could search for appropriate user ontologies relevant to the user context as illustrated in FIG. 4.

The inference chain relationship would now entail the following:
<user problem context>→<domain ontologies>→<web sites>→<web services, web content>

With this view there are ontologies defining specific user problem context types and associated application domain ontologies, which have references to specific web sites. These relationships can be predefined, where a web site provider would as part of the publishing process, also select the relevant domain ontologies that the site is consistent with, and also the user context that might be associated with this domain. The former is probably more accurate, while the latter relationship between user context and desired domain ontology is not easily discernible to the web site publisher.

In the case of a predefined environment where users, web sites and services are part of an narrower business model, where user roles and interests can easily be predefined, we can define the user context quite simply and associate application domain ontologies more appropriately. In the more general case it is not easily determined what the user problem context is, and the associated ontology domain and web services. In both cases it may be advantageous to enable the user to define the relationship between a user problem context definition and associated domain ontologies. It may also be advantageous for the system to aid in the creation of this relationship through machine learning of user session history.

User Problem Context Ontology

Each user situation can be defined through the use of a context ontology, where each context ontology could have the following information. Where a context attribute is defined as a set it is possible that a particular context may be valid for a user with only a sub set of values for that attribute. The context attributes in bold should be specified for every user problem context ontology, while other context attributes can be selected from below or specified as appropriate for the context as <Context Attribute i>. In this way the context definition itself can be extended.

A context is thus defined at a minimum as a set of <attribute, value> pairs contained within a context ontology. Other expressions may be part of the context meta specification that further defines relationships between the attributes and any constraints. This could take the form of typical ontology expression triples such as <subject predicate object>. For example a set of context expressions might relate a specific <User Role> with a specific <User Intent>. Using modus ponens, e.g., A, A→B: B.
<Role Provider>
<Business Process Create Information>
<Role Provider>λ<Business Process Create Information>
→<Intent Publish Information Object>
<Intent Publish Information Object>

The above expression states that if the user role is that of provider, the user is creating information, that the Publish Information is the likely consequence given the Role and Business Process values; then we can say that Intent is to Publish Information inferred result.

Context Ontology Specification

<Context Name>=“unique flat name to identify context”
<Context id>=“URID”
<Parent Context id>=“identifies a parent context that this context inherits attributes from”
<Description>=“free form text description for browsing by human users”
<Role>=“set of predefined roles appropriate within a context, consumer, provider, browser, . . . ”
<Business Process>=“the set of business processes a user could be engaged in this context”
<Intent>=“the set of possible intentions or results the user desires in this context”
<Social Environment>“predefined set of social environments across contexts, business, personal, . . . ”
<User Mobile Environment>=“defines user mobile environment, fixed location, mobile pedestrian, mobile vehicle, . . . ”
<User Communications Capability>=‘defines user communication capabilities, cellular, wireless PDA, wireline phone, PC with WiFi, . . . ”
<User computing capability>=“PC, Laptop, PDA, . . . ”
<User Personal State>=“biometric information”
<Date, Day, Time>=“Temporal Information”
<Security>=“security preferences of user for this context, privacy, content sharing management, . . . ”
<Context specific attribute #, Attribute Name>=“a context specific attribute 1 to n, its name and and their possible values”
<Shared SAF Knowledge>
<context expressions>
   Multiple User Problem Contexts—Structure

A context ontology will have UML like properties of inheritance. Each context can inherit attributes of a parent context, and specialize it by adding more attributes, or by constraining the values for inherited attributes. In this way it is possible ultimately for users to customize their own contexts from other context definitions. A context can only have one parent, otherwise there is the possibility of inconsistent context definitions. Context aggregation, where a context is created from other contexts, is supported by a process similar to ontology aggregation.

Creation

It is proposed that a set of common user context ontologies can be created for a web business model by the information system manager; then customization of these a'priori context ontologies can be accomplished by specialization as in UML class specialization discussed previously. Of course we must separate the creation of a specific context ontology, from the creation of a context knowledge base instance formed from evaluation of user and other information data.

Selection

From the attributes of the universally defined context ontology, a set of current data values for a user are collected for each attribute. Then these are matched according to a classification algorithm with a set of context ontologies to identify candidate context ontologies that potentially match the user data. Then an optimal classification algorithm is used to select the most likely hypothesis that fits the user's context. This may involve additional data once the candidates are selected to help determine which candidate is the optimal match. One approach is that a form of Naïve Bayesian classifier be used to calculate the probability of the most likely context hypothesis. In this inductive learning model the classifier is given a set of training examples {<xi, f(xi)>}, where xi is the set of context attribute values, and f(xi) is the context classification for that set of values. The Bayesian classifier algorithm is then used to learn a hypothesis that correctly classifies each training example's context. It then can be used after training to classify candidates and the optimal context ontology.

There are many different machine learning algorithms that can be used to learn how to select the context candidates and the optimal context ontology hypothesis. What is important in this paper is the relationship between the user context and the set of web domain ontologies and their associated web sites having semantic content and semantic web services. See FIG. 5

Modes for Creation of User Context Relation with Application Domain Ontologies

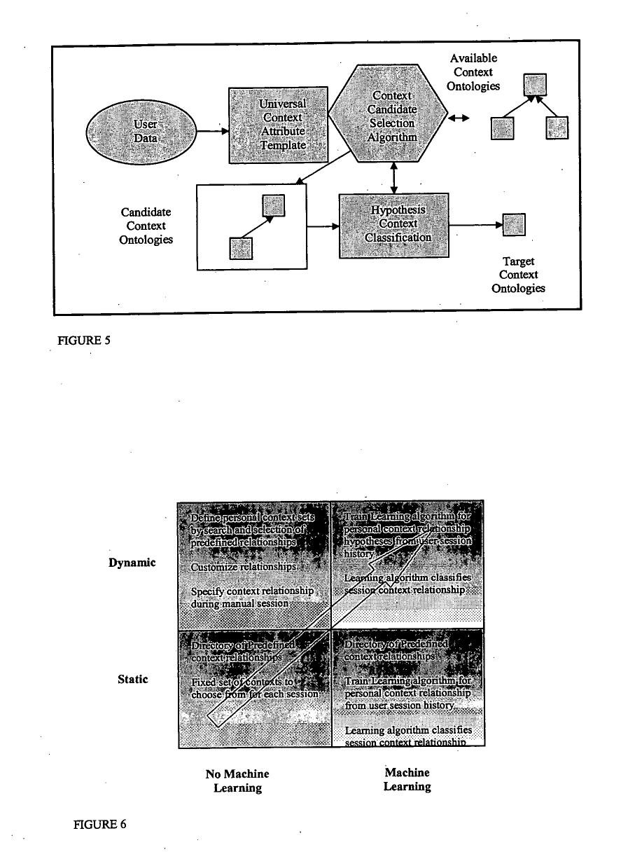

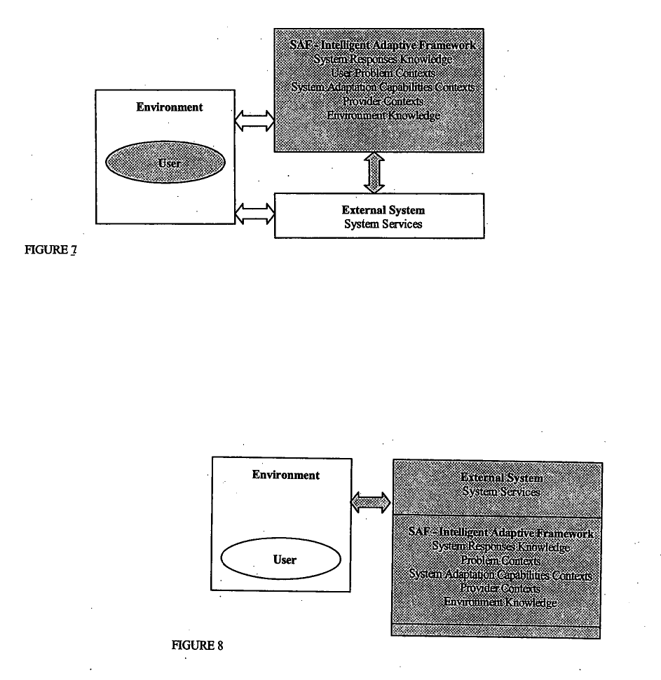

FIG. 6 shows the following possibilities for establishing the user context relationship with application domain ontologies, and thus web services and content.

Static User Context—No Machine Learning

The static user context is defined from a directory of predefined contexts and their associated domain ontology relationships. For a particular system, application context relationships and context ontologies could be defined for the most common situations among the typical community of users for that environment. Ideally they would satisfy most users and the predefined set could be extended as the system information manages learns more about common context needs and situations.

The system would only have a predefined set of contexts and relationships to domain ontologies, established by the system information manger. For any specific session the user would browse a directory or a cache of recently used contexts for selection purposes.

Dynamic User Context

The user context relationship to application ontologies is defined manually by the user over time, and is customized from the preexisting set of predefined relationships. Each user is thus able to customize and personalize the static context environment described previously.

Static User Context—Machine Learning

In this situation machine learning learns to classify the context relationship from a directory of available context-application domain relationships. This removes the need for manual selection by the user over time as the classifier learns from experience. A certain number of user manual sessions can be selected as training examples for the classifier learning algorithm.

Dynamic User Context—Machine Learning

In this situation machine learning not only classifies the context, and the context-application relation, but also chooses the optimal selected responses.

SAF Application Environment Models

User, External System and SAF

Another view is that the SAF system interacts with an external system on behalf of a user/client, and uses self knowledge of the environment, user context, and external system services to select the optimal services for the user. See FIG. 7.

SAF within a System

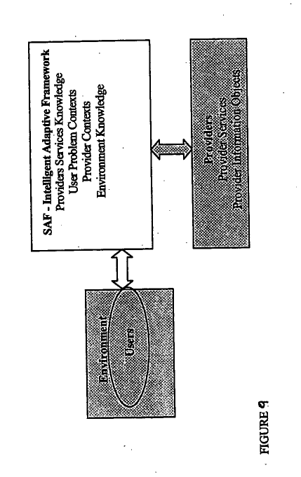

In this model FIG. 8, the SAF is totally contained within the system providing the services but adds an intelligent layer of behavior control for specific system problems. Example problem contexts could include:
Optimizing system resources for offered traffic from users
Determining failure recovery actions
Controlling congestion when the external environment overloads the system
Managing the optimal routes and structure for a network
Controlling user access to system services
   SAF and Distributed Environments and Systems

Imagine an environment consisting of multiple users, multiple shared information objects, and services\providers; SAF could perform the function of associating users, information objects, and service providers in this distributed environment.

This environment, FIG. 9, shows that the changing user problem context provides a mechanism to predefine, learn, and select provider information objects and services.

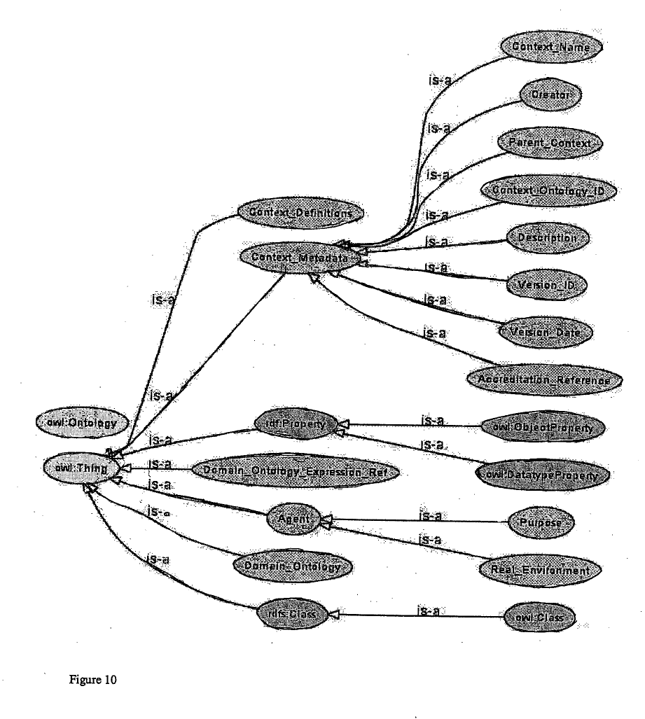

As described herein, the SAF has the dependence upon a set of interrelated ontologies. The diagram shown in FIG. 10 illustrates the type of information contained in the “Context Ontology”. The diagram represents only a small fraction of the knowledge model represented in the standard Web ontology language OWL. (http://www.w3.org/2001/sw/WebOnt/) The concept defined is to create a Context_Definitions class with properties to Domain_Ontology, and to Domain_Ontology_Expression_Ref. These properties, not illustrated in the above diagram but contained in another OWL ontology diagram, enable any context definition to reference any domain ontology, and the set of concepts or subsets of its local model to define a context.

Model Concepts

The above ontology model of FIG. 10 is based on the following concepts:
1. A set of specific domain ontologies referred to by situational ontology models
2. Core situational ontologies independent of agents
3. Agent ontologies, defining different agent situations
4. Context Ontologies relating agent ontologies, core situational ontologies, and domain ontologies

Additional Context_Metadata is also defined to enable management of context ontologies. The present invention may also be used in connection with
1. Context Ontology discovery metadata—specific metadata that enables searches for context ontologies based on the domain ontologies associated with the context
2. Agent Context Ontologies—Specific situational, environmental, and purposeful ontologies that can be used to define an agents context.
3. Action or task ontologies that can be related to the overall Context Ontologies by the SAF model
4. Complete OWL ontology model comprising the core situational ontologies, and the elements of an agent ontology.

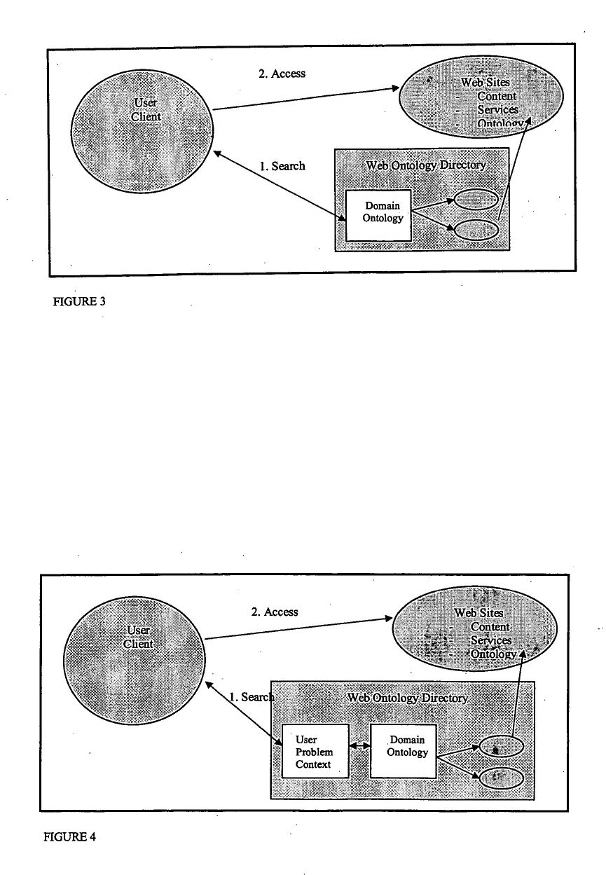

The present invention may be used in a variety of different situations. One example is a network system The network includes a network cable or wireless communication means to which a server and one or more clients are connected. The cable or wireless communication means may be also connected to the internet and/or public or private databases preferably through a firewall. The network may be any one of a number of conventional network systems, including a local area network (LAN) or a wide area network (WAN), as is known in the art. The server includes hardware necessary for running software to access data for processing user requests and provide an interface for serving information to client machines. In a preferred embodiment, the software running on the server machine supports the World Wide Web (web) protocol for providing page data between a web server and a client as illustrated in FIG. 3. The web application provides a user interface between server and a client. The server receives information through the network to carry out instruction provided by a user, and requests are directed to the appropriate hardware and analysis applications. As may be necessary, the server may be distributed over two or more machines. A first server may be a web server running web applications and the second server may be an analysis server running analysis applications.

The invention can provide a number of advantages for the web system described, especially where the user desires to have adaptation of visible and accessible web services and web site content adapted to the user particular situation or context as illustrated in FIG. 4. The SAF could be distributed across the user device and the web servers, where the SAF layer would provide the capability to store each individual user's set of diffeent context situations, and then logically adapt the overall system to display web services and web content applicable to the user's context. For example user situation clues such as time of day, day of week, and user location could be indicators of one or more user predefined contexts, such as the switch from a work context to a family context, which would enable the SAF to adapt the user's device display to indicate a different set of web services and content more appropriate to a user's family communication and web services needs. The SAF could also provide the logical control to adapt web media content to the capabilities of a particular user device, and/or access web mediation services to adapt content to the user's device.

1. A method of defining system behavior comprising
selecting optimal actions by a process of reasoning about a systems self knowledge wherein one or more of the following parameters are considered; the environmental state, system state, user situation, available system capabilities and network accessible functions and services and knowledge represented as ontologies.

2. The method according to claim 1 wherein the system is a self contained system.

3. The method according to claim 1 wherein said system is a Network Environment where the system is distributed across multiple nodes, each of said nodes being capable of sharing knowledge with each other node.

4. The method according to claim 1 wherein meta knowledge in the form of ontologies is used for the purpose of defining system responses, considering problem context, user context, environment knowledge, and available responses.

5. The method according to claim 1 wherein knowledge is shareable among a set of nodes through a Web Service and wherein where each node makes its knowledge and reasoning results available to other nodes thereby enabling a networked system with local reasoning appropriate to the system capabilities of each node.

6. The method according to claim 5 wherein the use of standard Web Services standard enables a common platform independent network within a heterogeneous network.

7. The method according to claim 6 wherein said Web Service is UDDI

8. The method according to claim 6 wherein said Web Service is WSDL

9. The method according to claim 1 wherein explicit self knowledge enables reasoning to guide system behavior.

10. The method according to claim 1 wherein Network Accessible Knowledge enables reasoning to guide system behavior

11. The method according to claim 1 wherein environment data is analyzed by a classification learning algorithm to determine a candidate set of contexts and wherein context knowledge is not only the self knowledge of a single node but also the shared knowledge across nodes comprising a heterogeneous network.

12. The method according to claim 11 wherein a classification algorithm is used to select the most appropriate problem context hypothesis.

13. The method according to claim 12 wherein the specific ontology for a problem context is queried to determine the shared knowledge state.

14. The method according to claim 13 wherein a Context-Response-Relation is specified to link context knowledge to a set of appropriate system responses, workflows or actions, or information content.

15. The method according to claim 14 wherein a selected context and Context-Response-Relation expressions are evaluated to select responses, workflows, or content.

16. The method according to claim 15 wherein the results of selection are shared with other nodes

17. The method according to claim 16 wherein knowledge of a user/client and an environment and problem context enables a system to provide more relevant response to user/client requests.

18. The method according to claim 17 wherein self knowledge can be represented as a set of domain ontology specifications, which are defined as containing <domain vocabulary, grammar rules, inference rules, and a'priori axioms>.

19. The method according to claim 18 wherein reasoning and deliberation in said system has a specific goal of selecting the most relevant system response.

20. The method according to claim 19 wherein one or more machine learning algorithms can be used to train the system to select more optimal system responses with experience.

21. A system for defining behavior comprising
a means for selecting optimal actions by a process of reasoning about self knowledge wherein one or more of the following parameters are considered; the environmental state, system state, user situation, available system capabilities and network accessible functions and services and knowledge represented as ontologies.
